(19) United States
(12) Patent Application Publication
(10) Pub. No.: US 2006/0112745 A1
(43) Pub. Date: Jun. 1, 2006

(54) Apparatus for locking a device to a cycle footrest

(76) Inventor: James W. Collier, Upper Marlboro, MD (US)

Correspondence Address: CAHN & SAMUELS LLP, 2000 P STREET NW, SUITE 200, WASHINGTON, DC, 20036, US

(21) Appl. No.: 11/000,061

(22) Filed: Dec. 1, 2004

(51) Int. Cl. E05B 71/00

(52) U.S. Cl. 70/233

(57) ABSTRACT

A cycle footrest assembly including a footrest and a locking device fixedly mounted to the footrest. The locking device preferably includes a body, a locking mechanism, and a movable locking arm rotatably coupled to the body wherein the movable locking arm is operable by manipulating the locking mechanism.

### FIELD OF THE INVENTION

The present invention relates generally to footrests, and more particularly, to a cycle footrest including a lock accessory.

### BACKGROUND OF THE INVENTION

Operators of motorcycles often wear protective gear such as helmets, kneepads, and/or gloves to minimize injury that may occur from collisions and falls. Such protective gear is often of the utmost importance to the operator of the cycle as it may lessen the risk of injuries should a mishap occur. Further, in most jurisdictions in the United States, the law requires that a motorcycle operator, for example, wear a helmet while operating the cycle.

Some helmets are relatively heavy and/or occupy a significant amount of space. As a result, it is often inconvenient for the cycle operator to carry the helmet with him or her after parking the cycle. Accordingly, many cycle operators strap their helmets to their cycles after dismounting. Although this practice relieves the cycle operator of the inconvenience of carrying the helmet, it exposes the helmet to the risk of theft and damage.

In an attempt to overcome such a risk, helmet locking devices have been created to allow a cycle operator to secure the helmet to the cycle. For instance, some devices allow the helmet to be locked to a fork assembly of a cycle. Such a method includes drawbacks, however. For instance, the helmet can sway against the fork or against the wheel when a strong wind blows. Such swaying may result in damage to the helmet or to the fork or wheel. In addition, locking the helmet to a fork assembly may result in awkward positioning of the locking device. Thus, the operator may be inconvenienced when the operator attempts to place the key in the lock.

In addition to devices that allow locking of the helmet to a cycle fork assembly, some devices allow the helmet to be locked to a crossbar (for example, the vertical crossbar underneath the seat of a motorcycle). These devices also have drawbacks. For example, the clearance between the seat and the body on a motorcycle is often limited and thus results in limited space for storing a helmet. Thus, some helmets are too large to fit in the crossbar space. In addition, some riders attach saddle bags to the crossbar, thereby providing limited space for other attachments such as a helmet.

In addition, the limited clearance may impair access to the lock cylinder. For example, in some instances, the lock cylinder may rest in an “upside down” position in which the cylinder opening is oriented towards the ground. This may cause the cycle operator to have to bend downward or kneel to align the key with the lock cylinder.

Further, the size of the attachment points (for example, a fork or a crossbar) for helmet locks vary according to cycle type and make. For example, a crossbar on one cycle may be larger than a crossbar on another cycle. As a result, a helmet lock that will fit on the crossbar of one cycle may not fit on the crossbar of another cycle, thereby leaving the respective cycle rider without a viable option for securing his or her helmet.

In light of the foregoing, what is needed is a cycle footrest assembly including a conveniently accessible locking apparatus for locking a helmet to a cycle footrest.

### SUMMARY OF THE INVENTION

The present invention relates to a cycle footrest assembly including a footrest and a locking device mounted to the footrest configured to secure a helmet and reduce the risk of theft to the helmet. Locking the helmet to the footrest accommodates cycles which do not have other viable attachment points to which a helmet may be secured. Locking the helmet in such a manner also allows the cycle operator to gain easy access to the device when the time comes to unlock the device.

In at least one embodiment, the invention includes a cycle footrest assembly for allowing a helmet to be secured thereto. The cycle footrest assembly includes a footrest and a locking device fixedly mounted to the footrest and configured to secure the helmet. In an alternative embodiment, the cycle footrest assembly includes a locking device that is integrally formed with the footrest (e.g., molded or welded with the footrest). In still another embodiment, the cycle footrest assembly includes a locking device disposed within the footrest such that only the locking arm 120 extends beyond the footrest 102. The locking device of the footrest assembly preferably includes a body and a locking mechanism disposed within the body wherein the locking mechanism includes a keyslot configured to rotate within the body. The locking device further includes a movable locking arm rotatably coupled to the body wherein the movable locking arm is operable by manipulating the locking mechanism.

An objective of the present invention is to overcome the above-referenced problems of the prior art.

Another objective of the present invention is to provide a device that reduces the risk of theft of a helmet stored on a parked cycle.

Still another objective of the present invention is to provide a footrest assembly including a locking device that is compatible with a cycle regardless of its make and type.

An advantage of the present invention is that it allows a cycle operator to conveniently lock and unlock the locking device to attach or remove a helmet from the locking device.

Another advantage of the present invention is that it allows a cycle operator to safely secure a helmet to a cycle footrest while minimizing the risk of damage to the cycle and to the helmet.

Still another advantage of the present invention is that it provides a helmet locking option to a cycle that may not have another helmet locking option.

### BRIEF DESCRIPTION OF THE DRAWINGS

Like reference numerals in the figures represent and refer to the same element or function throughout.

FIG. 1A illustrates an exemplary footrest assembly in an unlocked state including a locking device configured to secure a helmet according to at least one embodiment of the present invention.

FIG. 1B illustrates the mounting brackets of the exemplary footrest assembly of FIG. 1A according to at least one embodiment of the present invention.

FIG. 1C illustrates the movable locking arm of the exemplary footrest assembly of FIG. 1A including an attached helmet according to at least one embodiment of the present invention.

FIG. 2A illustrates an exemplary footrest assembly in a locked state including a locking device configured to secure a helmet according to at least one embodiment of the present invention.

FIG. 2B illustrates the exemplary footrest assembly of FIG. 2A including an attached helmet according to an embodiment of the present invention.

FIG. 3A illustrates a side view perspective of an exemplary footrest assembly in an unlocked state including a locking device configured to secure a helmet according to an alternative embodiment of the present invention.

FIG. 3B illustrates interaction of the locking arm of FIG. 3A with an internal key gear according to an embodiment of the present invention.

FIG. 3C illustrates a side view perspective of the exemplary footrest assembly shown in FIG. 3A in a locked state including the locking device configured to secure a helmet according to an embodiment of the present invention.

FIG. 3D illustrates an end view perspective of the exemplary footrest assembly of FIG. 3A according to an embodiment of the present invention.

FIG. 3E illustrates an alternative embodiment of an exemplary footrest assembly having a bracket mounted into a groove on the footrest.

FIG. 4A illustrates a side view of an exemplary footrest assembly including a locking device disposed within the footrest assembly according to an alternative embodiment of the present invention.

FIG. 4B illustrates an end view of the exemplary footrest assembly of FIG. 4A according to an embodiment of the present invention.

### DETAILED DESCRIPTION OF THE INVENTION

As used herein, the term cycle includes a motorcycle or any other type of cycle with which the present invention may be used.

As used herein, the term footrest includes a footpeg, a pedal, or any other device for allowing an individual to rest a foot.

In particular, the footrest assembly of the present invention may be employed to allow a cycle operator to secure a helmet to a footrest of the cycle. Securing the helmet to the footrest assists in protecting the helmet from theft and allows the cycle operator to gain easy access to the locking device of the footrest assembly. Securing the helmet to the footrest is also ideal in that such a method for securing the helmet may be employed with most cycles, regardless of the make or type of cycle. In addition to securing a helmet to a cycle, the present invention may also be employed to secure other protective gear to a cycle such as protective gloves, kneepads, and the like.

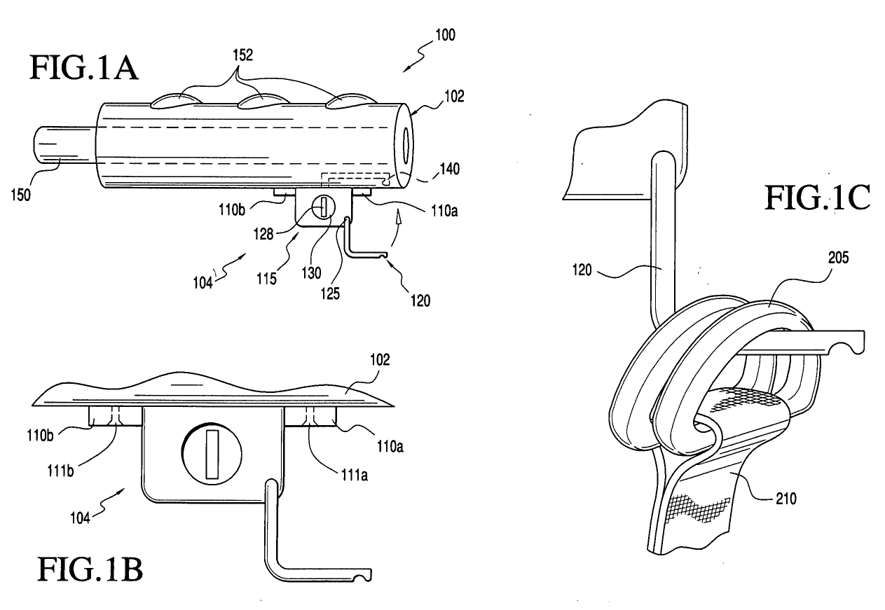

As illustrated in FIG. 1A, in at least one embodiment of the invention, the cycle footrest assembly 100 for allowing a removably attached device to be secured thereto includes a footrest 102 and a locking device 104 fixedly mounted to the footrest 102. The locking device is configured to secure the removably attached device. In at least one embodiment, the locking device 104 preferably includes a body, a locking mechanism disposed within the body wherein the locking mechanism includes a keyslot configured to rotate within the body, and a movable locking arm 120 rotatably coupled to the body 115 wherein the movable locking arm 120 is operable by manipulating the locking mechanism 130.

The footrest 102 is preferably a motorcycle footpeg such as those manufactured by Storz Performance, Inc., of Ventura, Calif. For example, as illustrated in FIG. 1A, in at least one embodiment, the cycle footrest 102 includes a mounting rod 150 configured to mount the footrest assembly 100 to a motorcycle, for example. In particular, the mounting rod 150 preferably extends through the footrest 102 and mounts to a motorcycle frame. In at least one embodiment, the cycle footrest 102 also includes a series of grip pads 152 configured to allow an individual's foot to rest thereon to prevent foot slippage.

The locking device 104 is preferably a locking device such as product number 4220, distributed by Kuryakyn™ corporation, of Somerset, Wis. As illustrated in FIG. 1B, the locking device 104 preferably includes mounting brackets 110a and 110b, which preferably allow the locking device 104 to be mounted to the cycle footrest 102 with at least one screw, for example. The mounting brackets 110a and 110b are preferably welded or molded with the locking device 104. The mounting bracket 110a includes a cavity (i.e., a screw hole) 111a for allowing a screw to proceed therethrough and into the footpeg 102, thereby assisting in securely attaching the locking device 104 to the footpeg 102. Similarly, the mounting bracket 110b includes a cavity 111b for allowing a screw to proceed therethrough and into the footpeg 102 to assist in securement of the locking device 104. In at least one embodiment, the brackets 110a and 110b are manufactured of steel, chrome, or any other viable material.

After being presented with the disclosure herein, one skilled in the relevant art will realize that the locking device 104 may be mounted in a variety of ways and locations. For example, the locking device 104 may also be mounted on a side or end of the footrest 102. It should also be noted that in at least one embodiment of the invention, the locking device 104 may be integrally formed with the footrest 102 (e.g., welded or molded).

As illustrated in FIG. 1A, in at least one embodiment, the body 115 houses a locking mechanism 130 and is preferably manufactured of metal such as steel. The locking mechanism 130 preferably serves as the means for operating the locking device 104. The locking mechanism 130 is preferably disposed within the body 115 of the locking device 104 and preferably includes a key slot and is configured to rotate within the body 115. For example, in at least one embodiment, the locking mechanism 130 is a lock cylinder, as would be known to those of ordinary skill in the relevant art after being presented with the disclosure herein. It should be noted, however, that in at least one embodiment of the invention, the locking device 104 includes a locking mechanism 130 including a combination locking system, as would be known to one of ordinary skill in the relevant art after being presented with the disclosure herein.

A movable locking arm 120 serves as the means for locking in the mountable locking device 104. The movable locking arm 120 is preferably L-shaped and is rotatably coupled to a point 125 on the body 115 of the locking device 104. The movable locking arm is preferably operable by manipulating the locking mechanism 130 (that is, the means for operating). The movable locking arm 120 is preferably manufactured of steel, chrome, or any other durable material.

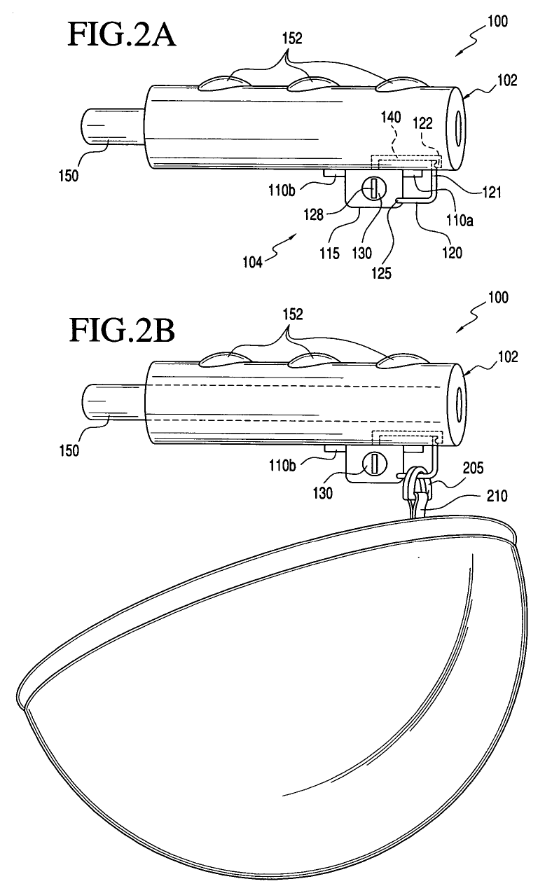

In at least one embodiment, the exemplary cycle footrest assembly 100 includes an elongated engagement bar 140 coupled to the body 115 and disposed within the footrest 102. In such an embodiment, the engagement bar 140 preferably remains stationary and is configured to connect to the movable locking arm 120 to secure the movable locking locking arm 120, as shown in FIG. 2A. The elongated engagement bar 140 serves as a stopping point for the movable locking arm 120. In at least one embodiment, the elongated engagement bar 140 telescopically receives the movable locking arm 120. In other words, the movable locking arm 120 connects to the elongated engagement bar 140 such that the connecting end 121 of the movable locking arm 120 telescopically enters the receiving end 122 of the engagement bar 140, thereby interlocking the movable locking arm 120 with the engagement bar 140, as shown in FIG. 2A. The elongated engagement bar 140 is preferably manufactured of metal or any other viable material.

To operate the locking device 104 to secure a helmet to the footrest 102, an operator places a key into the keyslot 128 of the locking mechanism 130 and unlocks the locking mechanism 130 with the key. The operator then preferably places an appendage of the item (for example, a metal ring(s) attached to the end(s) of a nylon looped strap of a motorcycle helmet) to be secured onto the L-shaped movable locking arm 120 such that the L-shaped movable locking arm 120 protrudes through the loop 205, as shown in FIG. 1C. After the operator places the appendage of the item onto the movable locking arm 120, the operator rotates the movable locking arm 120 in the direction shown in FIG. 1A until it interlocks with the engagement bar 140, for example, as shown in FIG. 2A. After the movable locking arm 120 interlocks with the engagement bar 140, the motorcycle helmet 210, for example, is secured to the footrest 102.

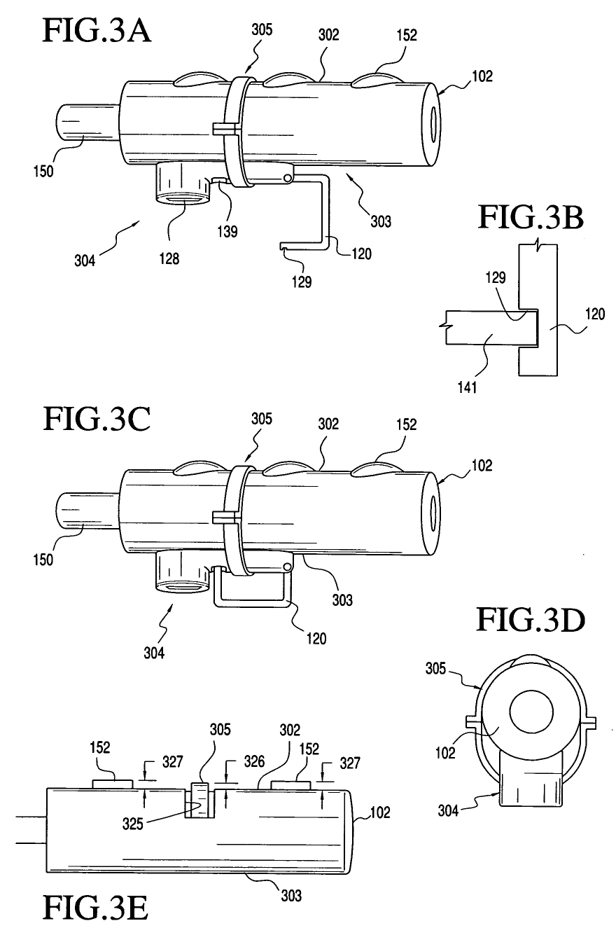

As illustrated in FIGS. 3A, 3C, and 3D, in an alternative embodiment, a securing apparatus 304 may be attached to the footrest 102 by at least one bracket 305, e.g., a C-shaped mounting bracket, that straddles the footrest 102. As shown in FIGS. 3A and 3C, in such an embodiment, the footrest 102 includes a first section 302 and a second section 303. The first section 302 includes at least one grip pad 152 coupled thereto. The second section 303 includes the securing apparatus 304 integrally formed with the footrest 102. The securing apparatus 304 includes the L-shaped movable locking arm 120 configured to secure the helmet to the footrest.

In at least one embodiment, the L-shaped movable locking arm 120 includes an indentation 129 which fits into opening 139 of the securing apparatus 304, as shown in FIG. 3A. Key gear 141 (shown in FIG. 3B) resides within the opening 139 (shown in FIG. 3A) of the securing apparatus 304. To operate the apparatus, an operator rotates the L-shaped movable locking arm 120 such that the indentation on the locking arm 120 enters the opening 139 of the securing apparatus 304. When the locking arm 120 gains entrance into the opening 139 of the securing apparatus 304, the operator preferably holds the locking arm 120. The operator then rotates a key inserted into the keyslot 128. Rotation of the key causes the key gear 141 to vertically slide into the indentation 129 of the L-shaped movable locking arm 120 (as shown in FIG. 3B), thereby securing the locking arm with the securing apparatus 304, as shown in FIG. 3C. In at least one embodiment, rotation of the key causes the key gear 141 to horizontally slide into the indentation 129 of the L-shaped movable locking arm 120, thereby securing the locking arm with the securing apparatus 304.

As illustrated in FIG. 3E, in at least one embodiment, the first section 302 of the footrest 102 includes at least one groove or indentation 325 configured to allow the bracket 305 to rest therein such that the bracket 305 extends from the first section 302 of the footrest 102 at a distance 326. In at least one embodiment, the distance 326 is equal to or almost equal to a distance 327 by which the at least one grip pad 152 extends from the first section 302 of the footrest 102. The bracket 305 is preferably covered with a bracket grip pad.

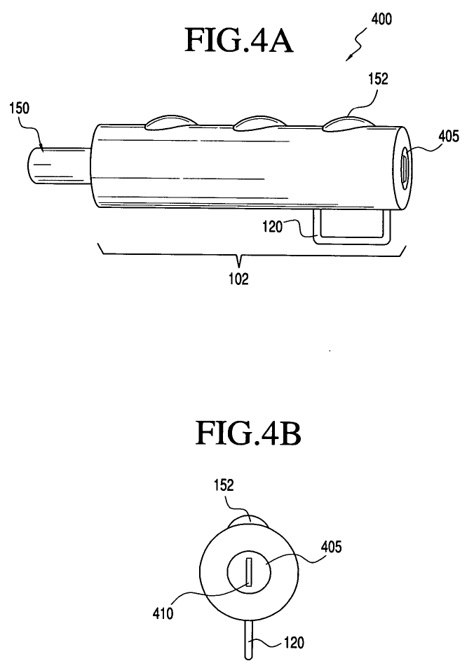

As illustrated in FIGS. 4A and 4B, in another alternative embodiment of the invention, a cycle footrest assembly 400 includes the footrest 102. The footrest assembly 400 preferably includes a mounting rod 150 for mounting to a motorcycle, for example. The footrest assembly 400 further preferably includes at least one grip pad 152 configured to prevent an individual's foot from slipping from the footrest 102. Instead of a mounted locking device, however, the footrest assembly 400 preferably includes a locking device 405 disposed within the footrest 102 such that only the locking arm 120 extends beyond the footrest 102. As illustrated in FIG. 4B, the locking device 405 is preferably disposed at one end of the footrest 102 so that keyslot 410 is substantially flush with the end of the footrest 102. Such a construction permits the user to easily insert a key into the keyslot 410 and thereby operate the footrest assembly 400.

Those skilled in the art will appreciate that various adaptations and modifications of the above-described embodiments of the present invention can be configured without departing from the scope and spirit of the present invention. For instance, a variety of types of locking devices may be utilized with the locking apparatus of the present invention without departing from the spirit and scope of the invention. Therefore, it is to be understood that, within the scope of the appended claims, the invention may be practiced and constructed other than as specifically described herein.

1. A cycle footrest assembly for allowing a removably attached device to be secured thereto, comprising:
a footrest; and
a locking device mounted to said footrest wherein said locking device is configured to secure the removably attached device to the footrest.

2. The cycle footrest assembly of claim 1, wherein said locking device includes:
a body;
a locking mechanism disposed within said body; said locking mechanism including a keyslot configured to rotate within said body; and
a movable locking arm rotatably coupled to said body, said movable locking arm being operable by manipulating said locking mechanism.

3. The cycle footrest assembly of claim 2, wherein said movable locking arm is L-shaped.

4. The cycle footrest assembly of claim 2, further comprising an elongated engagement bar coupled to said body and disposed within said footrest, said elongated engagement bar configured to connect to said movable locking arm to secure said locking arm.

5. The cycle footrest assembly of claim 2, wherein said locking mechanism is a lock cylinder.

6. The cycle footrest assembly of claim 1, wherein said locking device is mounted to said footrest with at least one mounting bracket and at least one screw.

7. The cycle footrest assembly of claim 1, wherein said locking device is welded to said footrest.

8. (canceled)

9. A cycle footrest assembly for securing a helmet, comprising:
a footrest including a first section and a second section, said first section including at least one grip pad coupled thereto, said grip pad extending from said footrest;
a securing apparatus attached to said second section of said footrest, said securing apparatus including a locking arm rotatably coupled to said securing apparatus and adapted to secure the helmet to the footrest assembly; and
at least one mounting bracket, said at least one mounting bracket straddling said footrest and attaching said securing apparatus to said footrest.

10. The cycle footrest assembly of claim 9, wherein said first section of said footrest includes at least one groove, said at least one groove configured to allow said mounting bracket to rest therein such that said mounting bracket and said at least one grip pad extend beyond said first section of said footrest at an equal distance.

11. A cycle footrest assembly for allowing a helmet to be locked thereto, comprising:
a footrest; and
a locking device disposed within said footrest, said locking device including
a body;
a means for operating the locking device disposed within said body, said means for operating including a key slot configured to rotate within said body; and
a means for locking rotatably coupled to said body, said means for locking being operable by manipulating said means for operating.

12. The cycle footrest assembly of claim 11, wherein said means for locking is an L-shaped locking arm.

13. The cycle footrest assembly of claim 11, further comprising an elongated engagement bar coupled to said body and disposed within said footrest, said elongated engagement bar configured to connect to said means for locking to secure said means for locking.

14. The cycle footrest assembly of claim 11 wherein said means for locking includes a combination lock system.

15. The cycle footrest assembly of claim 11, wherein said locking device is welded to said footrest.

16. The cycle footrest assembly of claim 4 wherein said movable locking arm includes a connecting end that engages a receiving end of the engagement bar.

17. The cycle footrest assembly of claim 9 wherein said locking arm includes a first end having an indentation and said securing apparatus includes an opening adapted to receive the first end of said locking arm and a key gear adapted to engage the indentation and thereby secure the locking arm.

18. The cycle footrest assembly of claim 1 wherein the body of said locking device is disposed within said footrest such that the keyslot is substantially flush with an end of said footrest and the locking arm extends beyond said footrest.

19. The cycle footrest assembly of claim 9 wherein said securing apparatus includes a body and a locking mechanism disposed within said body, the securing apparatus being integral with said footrest.
